(19) United States
(12) Patent Application Publication
(10) Pub. No.: US 2006/0092454 A1
(43) Pub. Date: May 4, 2006

(54) Printing device and printing method

(75) Inventors: Atsushi Narusawa, Nagano-ken (JP); Satoru Orii, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/976,315

(22) Filed: Oct. 29, 2004

(51) Int. Cl. G06F 3/12

(52) U.S. Cl. 358/1.15

(57) ABSTRACT

Every time a specified URL is given, an analyzer unit 30 stores the specified URL into a URL storage buffer area of a memory 50, whether or not an XHTML document is being currently analyzed. When any URL is present in the URL storage buffer area of the memory 50, the analyzer unit 30 successively reads and analyzes an XHTML document identified by the specified URL to create a DOM tree, and stores the DOM tree into a DOM tree storage area of the memory 50, whether or not a layouter 38 is currently making a layout.

### BACKGROUND OF THE INVENTION

1. Field of the Invention

The present invention relates to a printing device, a printing method, and a program for the printing device. More specifically the invention pertains to a printing device that analyzes a document, which describes printable objects in a hierarchical manner in a preset format, and prints the objects on a medium, such as paper, as well as to a corresponding printing method.

2. Description of the Prior Art

One proposed printer system includes a printer that analyzes and prints an SVG document and a formatting server that converts an HTML document into the SVG document (see, for example, Japanese Patent Laid-Open Gazette No. 2002-91726). In this proposed printer system, the formatting server converts a received HTML document into an SVG document, and the printer analyzes and prints the converted SVG document.

### SUMMARY OF THE INVENTION

This prior art printer system including the printer and the formatting server is, however, undesirably large in size and is unsuitable for a restricted space, such as a living room in a house. This printer system converts the received HTML document into the SVG document and analyzes and prints the converted SVG document. Such conversion and analysis take a relatively long time and undesirably interfere with prompt printing.

The printing device and the corresponding printing method of the invention aim to promptly analyze and print a document that describes objects in a hierarchical manner in a preset format, for example, an HTML document or an extended HTML document.

At least part of the above and the other related objects is attained by a printing device and a corresponding printing method of the invention constructed as discussed below.

The printing device of the invention is the printing device that analyzes a document, which describes printable objects in a hierarchical manner in a preset format, and prints the objects on a medium, such as paper, and the printing device includes: a data storage module that stores data; a structural analysis module that, in response to specification of one document, receives the specified document and starts analysis of a hierarchical tree structure of the objects described in the received document at a preset timing even before a printing process of another document specified in advance is concluded, and stores the analyzed tree structure into the data storage module; a layout setting module that, in response to a layout command, determines a layout of the objects in each page on the medium, based on the tree structure stored in the data storage module, and stores the determined layout in each page into the data storage module; and

a print execution module that, in response to a print command, fetches the objects according to the layout in each page stored in the data storage module and lays out and prints the fetched objects on the medium.

In response to specification of one document, the printing device of the invention receives the specified document and starts analysis of the hierarchical tree structure of the objects described in the received document at the preset timing even before the printing process of another document specified in advance is concluded. The printing device of the invention thus attains prompt analysis and printing of a currently specified document, compared with the prior art printing device that starts analysis of a currently specified document only after completion of the printing process of another document specified in advance. The document may be described in a markup language, such as XHTML language. The printable objects include texts, images, and tables. One typical example of the printing device is a color inkjet printer.

In the printing device of the invention, the structural analysis module may start analysis of the specified document at the preset timing when analysis of the tree structure of another document is completed. In this case, the layout setting module may output a predetermined termination signal to the structural analysis module after completion of a layout with regard to a previously analyzed tree structure, and the structural analysis module, in response to reception of the predetermined termination signal, may give a layout command for a currently analyzed tree structure, which is subsequent to the previously analyzed tree structure with the output of the predetermined termination signal, to the layout setting module. Further, in this case, the layout setting module may delete the previously analyzed tree structure, for which the layout has already been determined, after completion of the layout.

Further, in the printing device of the invention, the structural analysis module may store the analyzed tree structure together with identification information for identifying the analyzed tree structure into the data storage module, and the layout setting module may receive a layout command with identification information and determine the layout according to the tree structure identified by the identification information received with the layout command, among tree structures stored in the data storage module. When a number of tree structures stored in the data storage module reaches a preset number, the structural analysis module may suspend reception of a next specified document and analysis of the hierarchical structure of the objects described in the next specified document until the number of the tree structures stored in the data storage module decreases below the preset number. In this case, the preset number may be equal to 2.

Moreover, in the printing device of the invention, the layout setting module may give the print command for each page with the determined layout to the print execution module. Additionally, the layout setting module may give the print command on completion of determination of the layout for one page to the print execution module.

The printing method of the invention is the printing method that analyzes a document, which describes printable objects in a hierarchical manner in a preset format, and prints the objects on a medium, such as paper, and the printing method includes the steps of: (a) in response to specification of one document, receiving the specified document and starting analysis of a hierarchical tree structure of the objects described in the received document at a preset timing even before a printing process of another document specified in advance is concluded; (b) in response to a layout command, determining a layout of the objects in each page on the medium, based on the analyzed tree structure; and (c) in response to a print command, fetching the objects according to the layout in each page and laying out and printing the fetched objects on the medium.

In response to specification of one document, the printing method of the invention receives the specified document and starts analysis of the hierarchical tree structure of the objects described in the received document at the preset timing even before the printing process of another document specified in advance is concluded. The printing method of the invention thus attains prompt analysis and printing of a currently specified document, compared with the prior art printing method that starts analysis of a currently specified document only after completion of the printing process of another document specified in advance.

The recording medium of the invention is the recording medium in which a program is stored, the program being used in a printing device that analyzes a document, which describes printable objects in a hierarchical manner in a preset format, and prints the objects on a medium, such as paper, and the program includes: a program module of, in response to specification of one document, receiving the specified document and starting analysis of a hierarchical tree structure of the objects described in the received document at a preset timing even before a printing process of another document specified in advance is concluded; a program module of, in response to a layout command, determining a layout of the objects in each page on the medium, based on the analyzed tree structure; and a program module of, in response to a print command, fetching the objects according to the layout in each page and laying out and printing the fetched objects on the medium.

The program stored in the recording medium of the invention is installed in the printing device. In response to specification of one document, the program activates the printing device to receive the specified document and start analysis of the hierarchical tree structure of the objects described in the received document at the preset timing even before the printing process of another document specified in advance is concluded. The program of the invention thus enables the printing device to promptly analyze and print a currently specified document, compared with the prior art program that causes the printing device to start analysis of a currently specified document only after completion of the printing process of another document specified in advance.

### BRIEF DESCRIPTION OF THE DRAWINGS

FIG. 1 schematically illustrates the structure of a color inkjet printer 20 in one embodiment;

FIG. 2 is a flowchart showing an analysis layout instruction process;

FIG. 3 is a flowchart showing an analysis process;

FIG. 4 shows one example of an XHTML document;

FIG. 5 shows images described in the XHTML document of the example;

FIG. 6 shows one example of a DOM tree;

FIG. 7 shows one example of a CSS document;

FIG. 8 shows one example of a style object;

FIG. 9 is a flowchart showing a layout drawing instruction process;

FIG. 10 is a flowchart showing a layout process;

FIG. 11 shows one example of a page box;

FIG. 12 is a flowchart showing a drawing process; and

FIG. 13 shows one example of a printing result.

### DESCRIPTION OF THE PREFERRED EMBODIMENTS

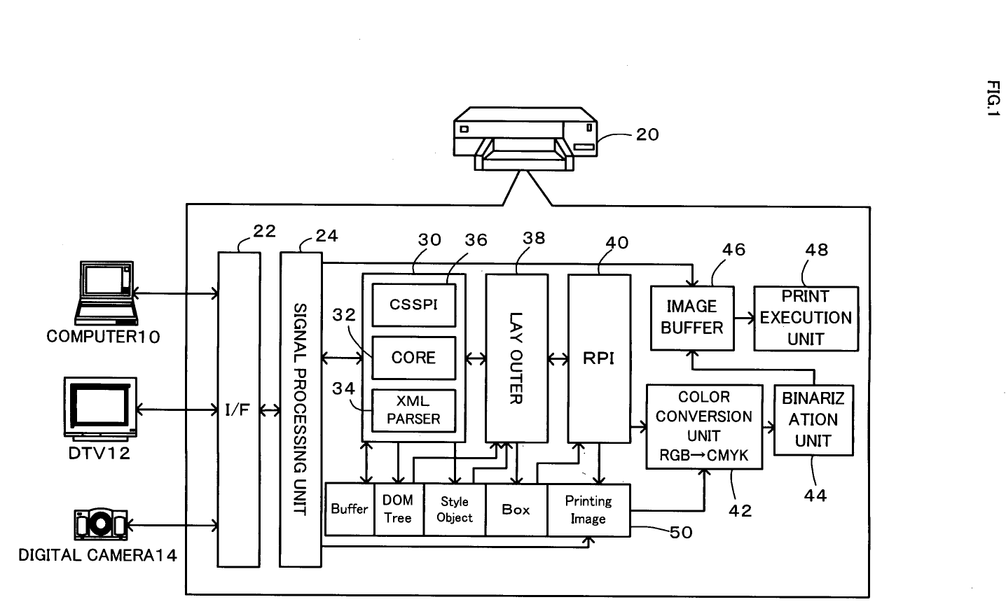

One mode of carrying out the invention is described below as a preferred embodiment. FIG. 1 schematically illustrates the structure of a color inkjet printer 20 in one embodiment of the invention. The color inkjet printer 20 of this embodiment includes an input interface 22 that is connected with a computer 10, a digital TV receiver 12, or a digital camera 14 to input digital images (hereafter simply referred to as images), a signal processing unit 24 that determines an output destination of data according to the format of each image input by the input interface 22, and an analyzer unit 30 that analyzes an XHTML document described in a markup language XHTML (extensible Hyper Text Markup Language) to create a DOM (Document Object Model) tree as an object tree structure, reads a CSS (Cascading Style Sheets) document described in CSS to create a style object, and writes the DOM tree and the style object into a memory 50. The color inkjet printer 20 also includes a layouter 38 that lays out images and text as objects described in the XHTML document on each printing page based on the DOM tree and the style object created by the analyzer unit 30 and writes each laid out printing page as a page box into the memory 50, a rendering plug-in (hereafter referred to as RPI) 40 that draws a printing image in the form of RGB (red, green, blue) data by utilizing the page box laid out by the layouter 38, a color conversion unit 42 that converts a printing image of the drawn RGB data into CMYK (cyan, magenta, yellow, black) data, a binarization unit 44 that makes the converted CMYK data subjected to error diffusion or another required series of image processing to binarize the CMYK data, and an image buffer 46 that temporarily accumulates data in order to output the binarized CMYK data in units of bands to a print execution unit 48 with a non-illustrated print head.

The signal processing unit 24 outputs immediately-printable print data to the image buffer 46 of the print execution unit 48, RGB data to a printing image storage area of the memory 50, and a file of the XHTML document to the analyzer unit 30.

The analyzer unit 30 includes a core 32 that gives an analysis command for analysis of the XHTML document to create the DOM tree, an XML parser 34 that analyzes the XHTML document in response to the analysis command given by the core 32, and a CSS plug-in (hereafter referred to as CSSPI) 36 that analyzes the CSS document in response to a request given by an initialization process in a link tag of the created DOM tree.

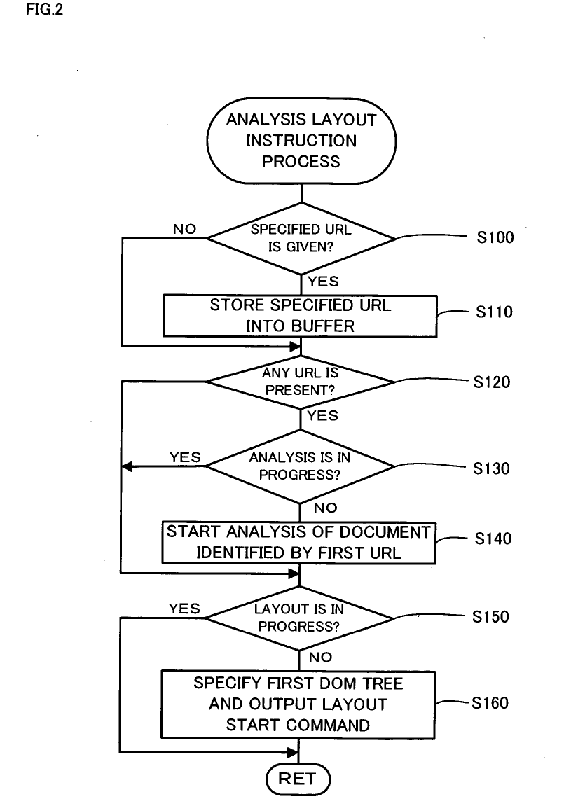

The following describes operations of the color inkjet printer 20 of the embodiment constructed as discussed above, especially a series of operations to print an XHTML document. FIG. 2 is a flowchart showing an analysis layout instruction process executed by the analyzer unit 30. This process is executed repeatedly at preset time intervals (for example, at every 8 msec). In the analysis layout instruction process, the analyzer unit 30 first determines whether a specified URL (Uniform Source Locator) is given to identify an XHTML document (step S100). When a specified URL is given, the URL is stored in a URL storage buffer area set in the memory 50 (step S110). When no specified URL is given, on the other hand, the program proceeds to a next step. The specified URL may be output, for example, from the digital TV receiver 12 to the color inkjet printer 20 when the operator selects a desired option to be printed by the color inkjet printer 20 among printable options displayed on the digital TV receiver 12. The specified URL may be selected simply by the computer 10 to give a print command to the color inkjet printer 20. The computer 10 has functions of executing analysis of the XHTML document, layout, color conversion, and binarization. The computer 10 may, however, not execute any of such processing but may send only the specified URL to the color inkjet printer 20.

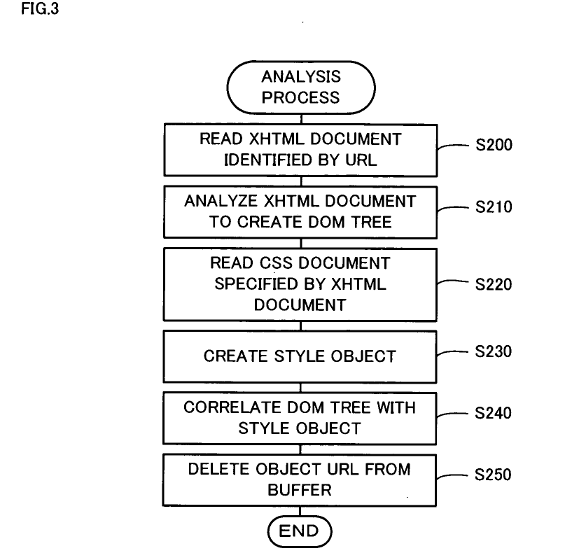

The analyzer unit 30 subsequently determines whether any URL is present in the URL storage buffer area of the memory 50 (step S120) and whether any XHTML document is currently being analyzed (step S130). The analyzing status of an XHTML document is detected, for example, by determining whether the analyzer unit 30 is currently analyzing any XHTML document, simultaneously with and in parallel with this analysis layout instruction process. One concrete procedure may set and reset a flag at the start and the end of analysis. When any URL is present in the URL storage buffer area and no XHTML document is currently being analyzed, the analyzer unit 30 reads out a first URL stored in the URL storage buffer area of the memory 50 and starts analysis of an XHTML document specified by the read out URL (step S140). When no URL is present in the URL storage buffer area or when any URL is present but an XHTML document is currently being analyzed, on the other hand, the program proceeds to a next step. Analysis of the XHTML document is carried out according to an analysis process shown in FIG. 3. The analysis process analyzes an XHTML document specified by a URL to create a DOM tree, analyzes a CSS document specified by the XHTML document to create a style object, correlates the DOM tree with the style object, and stores the correlated DOM tree and style object respectively into a DOM tree storage area and a style object storage area of the memory 50. A DOM tree ID as identification information is assigned to the DOM tree, whereas a style object ID as identification information is assigned to the style object. The details of the analysis process will be discussed later.

The analyzer unit 30 then determines whether the layouter 38 is currently making a layout (step S150). When the layouter 38 is not currently making a layout, the analyzer unit 30 specifies a first DOM tree with the DOM tree ID among DOM trees stored in the DOM tree storage area of the memory 50 and outputs a layout start command to the layouter 38 (step S160), before terminating this analysis layout instruction process. When the layouter 38 is currently making a layout, on the other hand, the analyzer unit 30 terminates the analysis layout instruction process without outputting a layout start command. The layout execution status of the layouter 38 is determined, for example, by detection of input of a layout end signal from the layouter 38. The input of the layout end signal will be described later as part of the processing by the layouter 38.

The analysis layout instruction process is executed in a repeated manner as mentioned above. Every time a specified URL is given, the analyzer unit 30 stores the specified URL into the URL storage buffer area of the memory 50, whether or not an XHTML document is being analyzed. When any URL is present in the URL storage buffer area of the memory 50, the analyzer unit 30 successively analyzes XHTML documents, whether or not the layouter 38 is currently making a layout. This may result in storage of multiple URLs in the URL storage buffer area, storage of multiple DOM trees in the DOM tree storage area, and storage of multiple style objects in the style object storage area of the memory 50. In the structure of this embodiment, the URL storage buffer area, the DOM tree storage area, and the style object storage area are respectively set to have the capacities for storing the multiple URLs, the multiple DOM trees, and the multiple style objects.

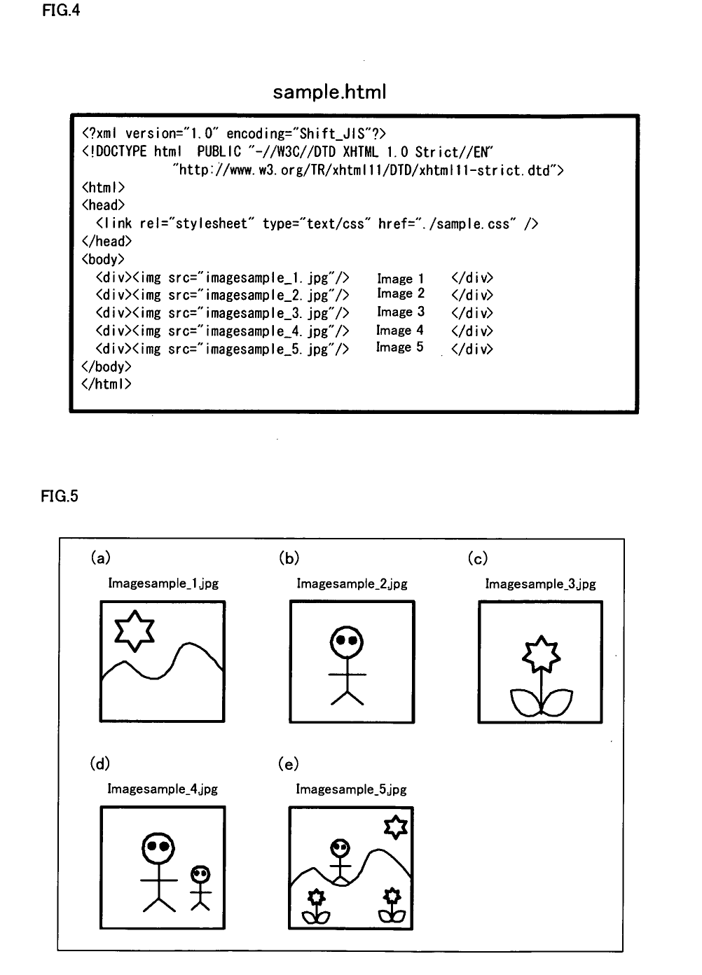

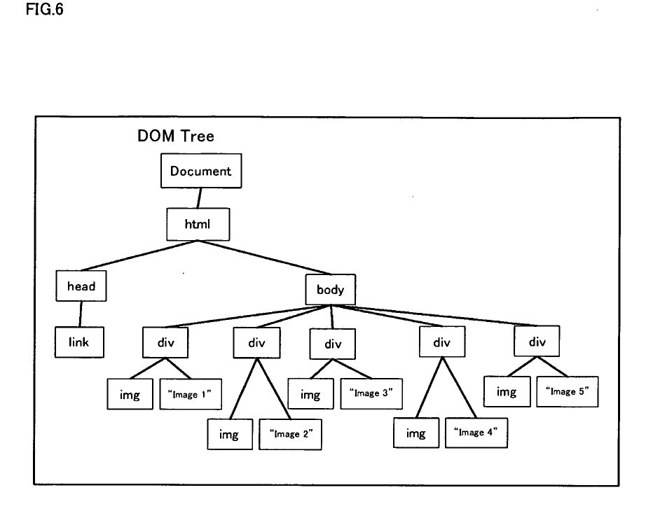

The description regards the analysis process executed by the analyzer unit 30. The analysis process is carried out according to the flowchart of FIG. 3 as mentioned above. As a matter of convenience, the description of the analysis process regards an XHTML document shown in FIG. 4 as one example. FIG. 5 shows five images stored in the JPEG format adopted in the XHTML document of the example. When the analysis layout instruction process outputs an analysis start command with a specified URL, the analyzer unit 30 reads an XHTML document identified by the specified URL (step S200) and analyzes the XHTML document to create a DOM tree (step S210). A DOM tree ID (for example, an ID prepared by adding a DOM to a URL) is assigned as identification information to the created DOM tree. According to the concrete procedure, the core 32 specifies a URL and gives an analysis request to the XML parser 34. The XML parser 34 reads the XHTML document specified by the URL and sequentially analyzes the XHTML document from the top to create respective elements and register the created elements in the form of a DOM tree. The XML parser 34 correlates the created elements and registers the correlated elements in the DOM tree storage area of the memory 50. FIG. 6 shows a DOM tree created by analysis of the XHTML document of FIG. 4.

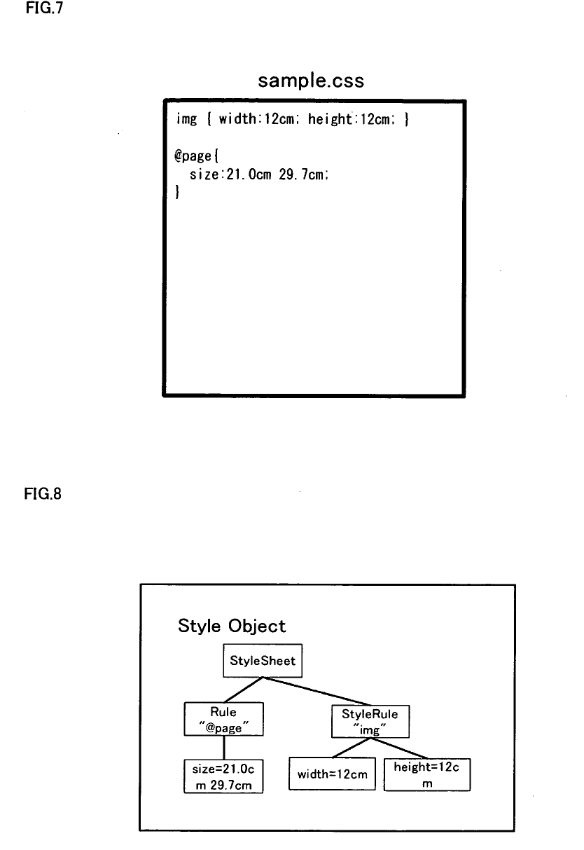

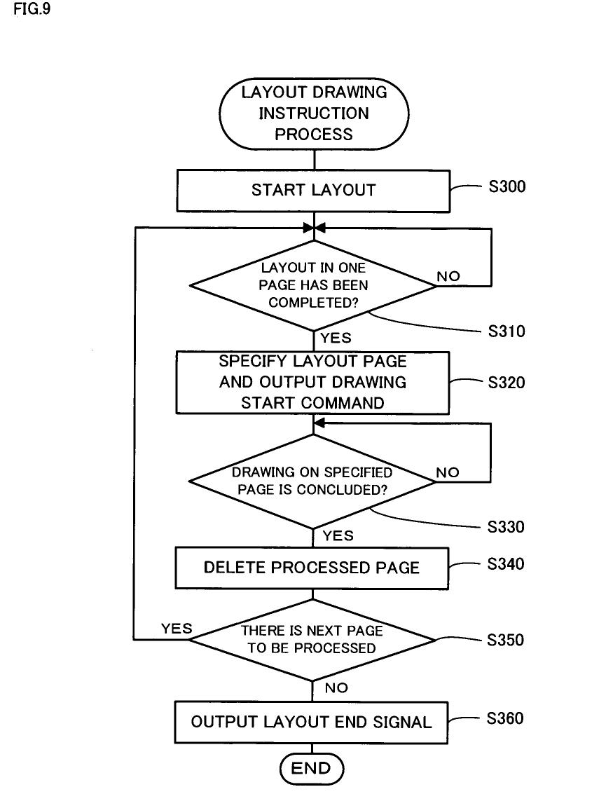

After creation of the DOM tree, the analyzer unit 30 reads a CSS document specified by the XHTML document (step S220) and analyzes the CSS document to create a style object (step S230) According to the concrete procedure, the CSSPI 36 reads the specified CSS document in response to a request given in an initialization process in a link tag of the created DOM tree, sequentially analyzes the CSS document from the top to create rules as a style object, and stores the created style object into the style object storage area of the memory 50. FIG. 7 shows a CSS document specified by the XHTML document of the example. FIG. 8 shows a style object created by analysis of this CSS document.

After creation of the DOM tree and the style object, the analyzer unit 30 correlates the DOM tree with the style object (step S240) and deletes the URL as the object of analysis from the URL storage buffer area (step S250), before terminating the analysis process.

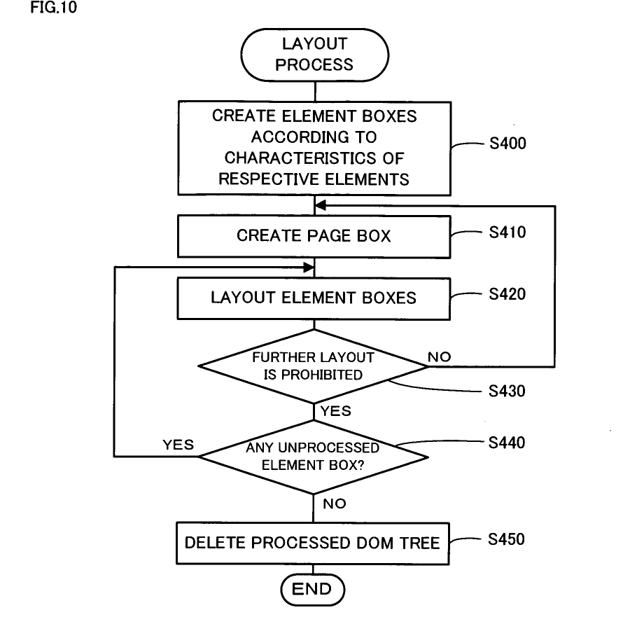

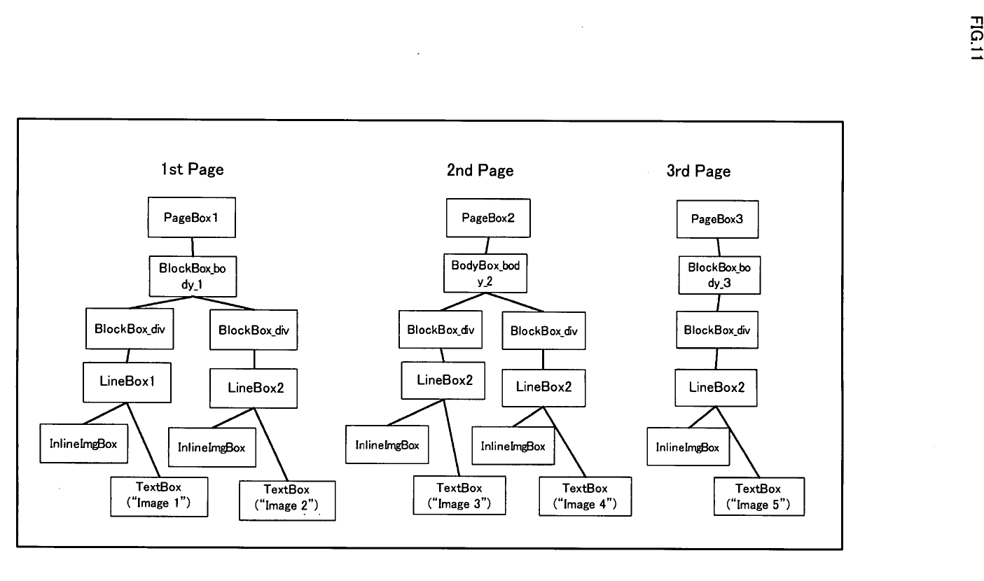

The description regards the series of processing executed by the layouter 38. FIG. 9 is a flowchart showing a layout drawing instruction process executed by the layouter 38 when the analyzer unit 30 specifies a DOM tree and outputs a layout start command. In the layout drawing instruction process, the layouter 38 starts a layout according to the specified DOM tree (step S300). The layout is made according to a layout process shown in the flowchart of FIG. 10. For convenience of explanation, the layout process is described first.

In the layout process, the layouter 38 first creates element boxes according to the characteristics of the respective elements included in the DOM tree (step S400). For example, the layouter 38 creates an image box corresponding to an image element, while creating a text box corresponding to a text element. The layouter 38 subsequently creates a page box corresponding to one page (step S410) and sequentially lays out element boxes in a body tag under the page box until prohibition of further layout (steps S420 to S440). The layout of an image box reads an image size, sets lines corresponding to the image size, and registers the image box on the lines. When the image size suggests an insufficient space for layout of the image box, further layout is prohibited at step S430. The layouter 38 accordingly creates another page box corresponding to a next page (step S410). The layout of text boxes creates a first text box corresponding to a first part of a text receivable in one line, registers the first text box on the line, creates a next text box corresponding to a next part of the text receivable in a next line, and registers the next text box on the next line. Such creation and registration are repeated to register all the text. In the event of failed registration of all the text to a last text box registered on a last line of one page, further layout is prohibited at step S430. The layouter 38 accordingly creates another page box corresponding to a next page and successively creates text boxes corresponding to the remaining text and registers the text boxes on respective lines in the above manner. FIG. 11 shows page boxes of respective pages as a result of layout according to the DOM tree of the example. After completion of the layout of all the element boxes, the layouter 38 deletes the specified DOM tree as the object of layout from the DOM tree storage area of the memory 50 (step S450) and terminates the layout process. The DOM tree as the object of layout is deleted from the DOM tree storage area of the memory 50 on conclusion of the layout process. This arrangement desirably prevents unnecessary storage of the processed DOM tree in the limited space of the DOM tree storage area and sets a space for storage of another DOM tree created by the analyzer unit 30.

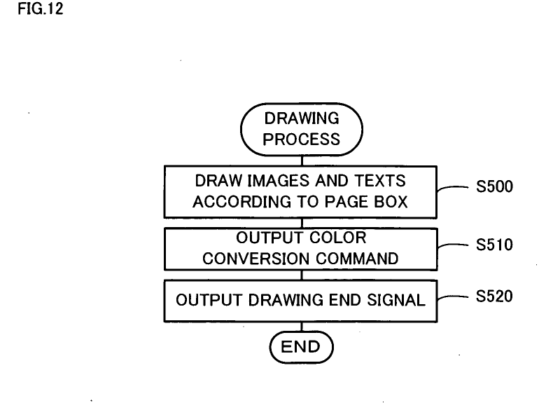

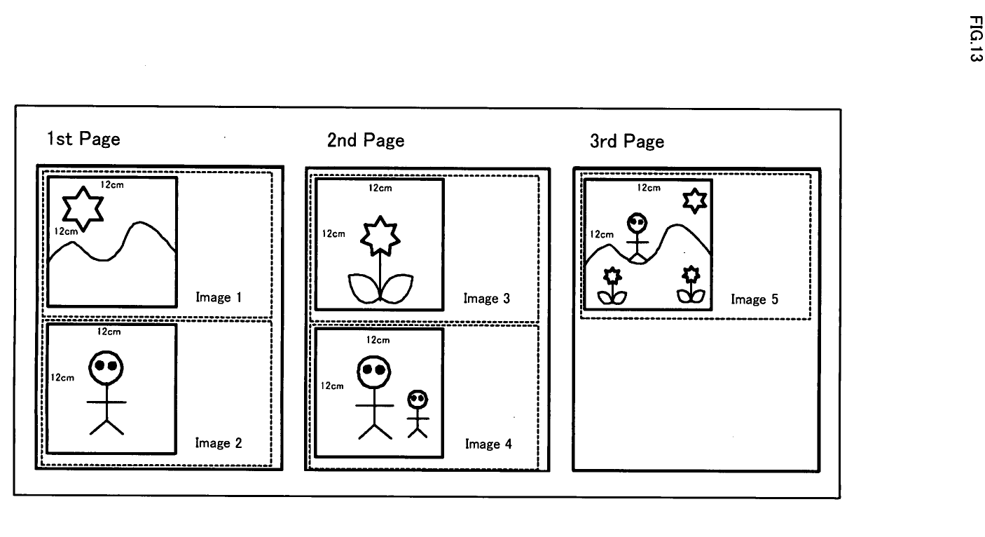

Referring back to the layout drawing instruction process (FIG. 9), the layouter 38 waits for completion of layout in one page (step S310) and specifies the layout page and outputs a drawing start command to the RP 140 (step S320). Completion of layout in one page is detected by determining whether or not a page box corresponding to a next page has been created or whether or not the layout process has been concluded in the case of only one page. The RP 140 receives the drawing start command and executes a drawing process shown in the flowchart of FIG. 12. The RP 140 draws texts and images according to the page box and stores the drawn texts and images as RGB data in the printing image storage area of the memory 50 (step S500). On completion of the drawing, the RP 140 outputs a color conversion command to the color conversion unit 42 (step S510) and outputs a drawing end signal to the layouter 38. The image drawing procedure reads an image file and draws an image with required processing, such as expansion, in some file formats. FIG. 13 shows a printing result of the example. The broken lines represent virtual areas of div tags included in the body tag, and the dimensions ‘12 cm’ shown on the top and the left sides of each image represent the image size described in the CSS document. The actual printing result naturally does not include the areas of the div tags and the image size.

After output of the drawing start command, the layouter 38 waits for completion of drawing on the specified page (step S330) and deletes the page box corresponding to the processed page (step S340). The page box as the object of drawing is deleted on completion of drawing on the corresponding page. This arrangement desirably prevents unnecessary storage of the processed page box in the limited space of a box storage area. After deletion of the processed page box, the layouter 38 determines whether there is a next page to be processed (step S350). When there is a next page to be processed, the processing flow goes back to step S310 to wait for completion of layout in the next page, specify the next layout page, and output a drawing start command to the RP 140. When drawing has been completed on all the pages and there is no other page to be processed, the layouter 38 outputs a layout end signal to the analyzer unit 30 (step S360) and terminates the layout drawing instruction process. The output of the layout end signal from the layouter 38 to the analyzer unit 30 enables the analyzer unit 30 to determine whether the layouter 38 is currently making a layout.

As described above, every time a specified URL is given, the color inkjet printer 20 of the embodiment stores the specified URL into the URL storage buffer area of the memory 50, whether or not an XHTML document is being currently analyzed. When any URL is present in the URL storage buffer area of the memory 50, the color inkjet printer 20 successively analyzes XHTML documents, whether or not the layouter 38 is currently making a layout. The color inkjet printer 20 accordingly stores a specified URL and reads and analyzes an XHTML document identified by the specified URL, whether or not the layouter 38 is currently making a layout. This arrangement ensures prompt analysis and printing, compared with the prior art printer system that reads and analyzes a next XHTML document identified by a URL for printing on completion of printing one XHTML document.

The memory 50 in the color inkjet printer 20 of the embodiment corresponds to the data storage module of the invention. The analyzer unit 30 including the core 32, the XML parser 34, and the CSSPI 36 corresponds to the structural analysis module of the invention. The layouter 38 corresponds to the layout setting module of the invention. The RP 140, the color conversion unit 42, the binarization unit 44, the image buffer 46, and the print execution unit 48 correspond to the print execution module of the invention.

When any URL is present in the URL storage buffer area of the memory 50, the color inkjet printer 20 of the embodiment successively analyzes XHTML documents, regardless of the number of DOM trees stored in the DOM tree storage area of the memory 50. When the number of DOT trees stored in the DOM tree storage area of the memory 50 reaches a preset number, analysis of a next XHTML document may be sustained until the number of the stored DOM trees decreases below the preset number. The preset number is, for example, 2. This arrangement desirably reduces, the required capacity of the DOM tree storage area in the memory 50.

When any URL is present in the URL storage buffer area of the memory 50, the color inkjet printer 20 of the embodiment starts analysis of a next XHTML document immediately after completion of analysis of one XHTML document. Analysis of a next XHTML document may start at any desirable timing after completion of analysis of one XHTML document.

The color inkjet printer 20 of the embodiment analyzes and prints XHTML documents described in XHTML language. The technique of the invention is also applicable to analyze and print documents described in another markup language, as well as documents described in any language other than the markup language.

In the configuration of the embodiment, the computer 10, the digital TV receiver 12, and the digital camera 14 are connected to the input interface 22 of the color inkjet printer 20. Any other suitable devices may be connected with the color inkjet printer 20.

The above embodiment regards the color inkjet printer that analyzes and prints XHTML documents as the printing device of the invention. The technique of the invention is also applicable to diversity of other printers, for example, color laser printers, monochromatic inkjet printers, and monochromatic laser printers.

The embodiment and its modified examples discussed above are to be considered in all aspects as illustrative and not restrictive. There may be many other modifications, changes, and alterations without departing from the scope or spirit of the main characteristics of the present invention.

What is claimed is:

1. A printing device that analyzes a document, which describes printable objects in a hierarchical manner in a preset format, and prints the objects on a medium, such as paper, said printing device comprising:
a data storage module that stores data;
a structural analysis module that, in response to specification of one document, receives the specified document and starts analysis of a hierarchical tree structure of the objects described in the received document at a preset timing even before a printing process of another document specified in advance is concluded, and stores the analyzed tree structure into said data storage module;
a layout setting module that, in response to a layout command, determines a layout of the objects in each page on the medium, based on the tree structure stored in said data storage module, and stores the determined layout in each page into said data storage module; and
a print execution module that, in response to a print command, fetches the objects according to the layout in each page stored in said data storage module and lays out and prints the fetched objects on the medium.

2. A printing device in accordance with claim 1, wherein said structural analysis module starts analysis of the specified document at the preset timing when analysis of the tree structure of another document is completed.

3. A printing device in accordance with claim 2, wherein said layout setting module outputs a predetermined termination signal to said structural analysis module after completion of a layout with regard to a previously analyzed tree structure, and
said structural analysis module, in response to reception of the predetermined termination signal, gives a layout command for a currently analyzed tree structure, which is subsequent to the previously analyzed tree structure with the output of the predetermined termination signal, to said layout setting module.

4. A printing device in accordance with claim 3, wherein said layout setting module deletes the previously analyzed tree structure, for which the layout has already been determined, from said data storage module after completion of the layout.

5. A printing device in accordance with claim 1, wherein said structural analysis module stores the analyzed tree structure together with identification information for identifying the analyzed tree structure into said data storage module, and
said layout setting module receives a layout command with identification information and determines the layout according to the tree structure identified by the identification information received with the layout command, among tree structures stored in said data storage module.

6. A printing device in accordance with claim 1, wherein when a number of tree structures stored in said data storage module reaches a preset number, said structural analysis module suspends reception of a next specified document and analysis of the hierarchical structure of the objects described in the next specified document until the number of the tree structures stored in said data storage module decreases below the preset number.

7. A printing device in accordance with claim 6, wherein the preset number is equal to 2.

8. A printing device in accordance with claim 1, wherein said layout setting module gives the print command for each page with the determined layout to said print execution module.

9. A printing device in accordance with claim 1, wherein said layout setting module gives the print command on completion of determination of the layout for one page to said print execution module.

10. A printing device in accordance with claim 1, wherein the document is described in a markup language.

11. A printing device in accordance with claim 10, wherein the markup language is XHTML language.

12. A printing device in accordance with claim 1, wherein the objects include at least one of texts, images, and tables.

13. A printing device in accordance with claim 1, said printing device being a color inkjet printer.

14. A printing method that analyzes a document, which describes printable objects in a hierarchical manner in a preset format, and prints the objects on a medium, such as paper, said printing method comprising the steps of:
(a) in response to specification of one document, receiving the specified document and starting analysis of a hierarchical tree structure of the objects described in the received document at a preset timing even before a printing process of another document specified in advance is concluded;
(b) in response to a layout command, determining a layout of the objects in each page on the medium, based on the analyzed tree structure; and
(c) in response to a print command, fetching the objects according to the layout in each page and laying out and printing the fetched objects on the medium.

15. A recording medium in which a program is stored, said program being used in a printing device that analyzes a document, which describes printable objects in a hierarchical manner in a preset format, and prints the objects on a medium, such as paper,
said program comprising: a program module of, in response to specification of one document, receiving the specified document and starting analysis of a hierarchical tree structure of the objects described in the received document at a preset timing even before a printing process of another document specified in advance is concluded; a program module of, in response to a layout command, determining a layout of the objects in each page on the medium, based on the analyzed tree structure; and a program module of, in response to a print command, fetching the objects according to the layout in each page and laying out and printing the fetched objects on the medium.
